(19) United States
(12) Patent Application Publication
(10) Pub. No.: US 2025/0225241 A1
(43) Pub. Date: Jul. 10, 2025

(54) IDENTIFICATION AND MITIGATION OF SPOOFING ATTACKS ON AUTONOMOUS VEHICLES

(71) Applicant: Kyndryl, Inc., New York, NY (US)

(72) Inventor: Cesar Augusto Rodriguez Bravo, Alajuela (CR)

(21) Appl. No.: 18/407,542

(22) Filed: Jan. 9, 2024

(51) Int. Cl. G06F 21/56; B60W 60/00

(52) U.S. Cl. CPC G06F 21/566; B60W 60/00188; G06F 2221/034

(57) ABSTRACT

Embodiments relate to the identification and mitigation of spoofing attacks on autonomous vehicles. A technique includes detecting using a sensor of the vehicle that an object appears in a path of the vehicle and preventing the vehicle from motion in response to detecting the object. The technique includes determining that the object is associated with a deception of the sensor of the vehicle and performing security actions in response to determining that the object is associated with the deception of the sensor of the vehicle.

### BACKGROUND

The present invention generally relates to computer systems, and more specifically, to computer-implemented methods, computer systems, and computer program products configured and arranged for the identification and mitigation of spoofing attacks on autonomous vehicles.

An autonomous vehicle is a vehicle capable of sensing its environment and operating without human involvement. A human passenger is not required to take control of the vehicle at any time, nor is a human passenger required to be present in the vehicle at all. An autonomous vehicle can travel anywhere a traditional car travels and do everything that an experienced human driver does.

The Society of Automotive Engineers (SAE) currently defines 6 levels of driving automation ranging from Level 0 (fully manual) to Level 5 (fully autonomous). These levels have been adopted by the U.S. Department of Transportation. The SAE uses the term automated instead of autonomous. One reason is that the word autonomy has implications beyond the electromechanical. A fully autonomous car would be self-aware and capable of making its own choices. A fully automated car, however, would follow orders and then drives itself. The term self-driving is often used interchangeably with autonomous. A self-driving vehicle can drive itself in some or even all situations, but a human passenger must always be present and ready to take control. Self-driving cars would fall under Level 3 (conditional driving automation) or Level 4 (high driving automation). They are subject to geofencing, unlike a fully autonomous Level 5 car that could go anywhere. Moreover, in some cases, a fully autonomous Level 5 car does not have a dashboard or a steering wheel, so a human passenger would not even have the option to take control of the vehicle in an emergency.

Autonomous vehicles rely on sensors, actuators, complex algorithms, machine learning systems, and powerful processors to execute software. Autonomous cars create and maintain a map of their surroundings based on a variety of sensors situated in different parts of the vehicle. Radar sensors monitor the position of nearby vehicles. Video cameras detect traffic lights, read road signs, track other vehicles, and look for pedestrians. Light detection and ranging (LiDAR) sensors bounce pulses of light off the car's surroundings to measure distances, detect road edges, and identify lane markings. Ultrasonic sensors in the wheels detect curbs and other vehicles when parking. Sophisticated software then processes all this sensory input, plots a path, and sends instructions to the car's actuators, which control acceleration, braking, and steering. Hard-coded rules, obstacle avoidance algorithms, predictive modeling, and object recognition help the software follow traffic rules and navigate obstacles.

### SUMMARY

Embodiments of the present invention are directed to computer-implemented methods for identifying and mitigating spoofing attacks on autonomous vehicles. A non-limiting computer-implemented method includes detecting using a sensor of the vehicle that an object appears in a path of the vehicle and preventing the vehicle from motion in response to detecting the object. The method includes determining that the object is associated with a deception of the sensor of the vehicle and performing security actions in response to determining that the object is associated with the deception of the sensor of the vehicle.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for automatically identifying and mitigating spoofing attacks on autonomous vehicles and performing security actions according to one or more embodiments of the present invention;

FIGS. 3A and 3B depict a flowchart of a computer-implemented method for automatically identifying and mitigating spoofing attacks on autonomous vehicles and performing security actions according to one or more embodiments of the present invention;

FIG. 4 depicts an example scenario for automatically identifying and mitigating spoofing attacks on autonomous vehicles and performing security actions according to one or more embodiments of the present invention;

FIG. 5 depicts a flowchart of a computer-implemented method for automatically identifying and mitigating spoofing attacks on autonomous vehicles and performing security actions according to one or more embodiments of the present invention;

FIG. 6 depicts a cloud computing environment according to one or more embodiments of the present invention; and

FIG. 7 depicts abstraction model layers according to one or more embodiments of the present invention.

### DETAILED DESCRIPTION

One or more embodiments automatically identify and mitigate spoofing attacks on autonomous vehicles by performing security actions. Technical solutions and benefits include a novel method and system to perform security actions in the event of spoofing attacks on autonomous vehicles. Technical solutions provide cybersecurity protection for autonomous vehicles. One or more embodiments assist potential victims avoid and/or mitigate potential harm or the threats of potential harm to passengers of the autonomous vehicle.

One or more embodiments described herein can utilize machine learning techniques to perform tasks, such as classifying a feature of interest. More specifically, one or more embodiments described herein can incorporate and utilize rules-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

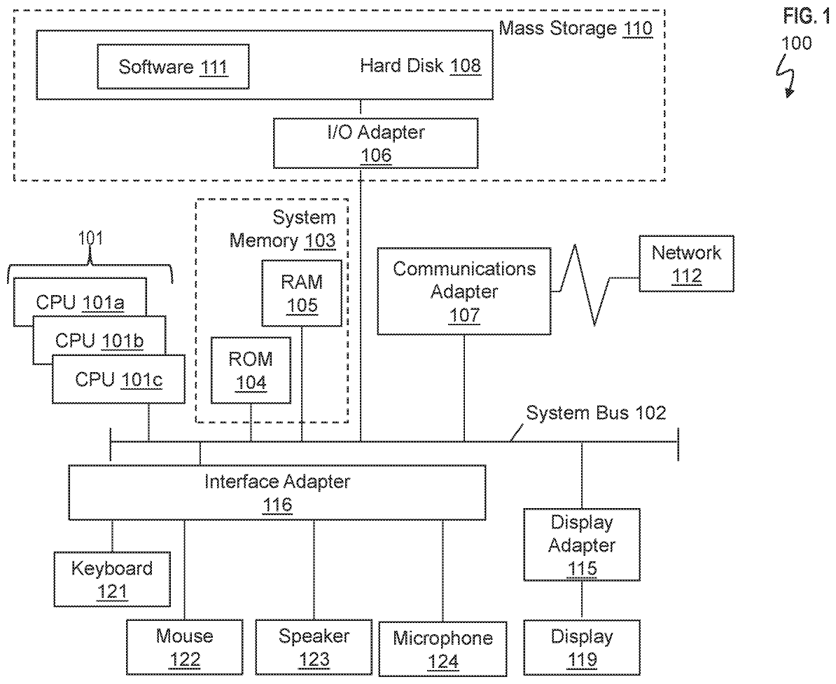

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

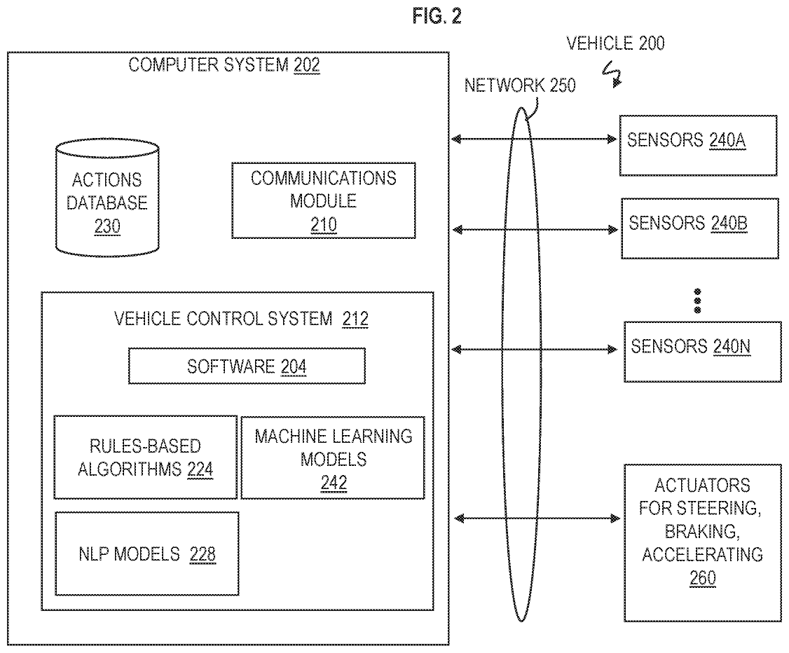

FIG. 2 depicts a block diagram of an example vehicle 200 configured for automatically identifying and mitigating spoofing attacks on autonomous vehicles and for automatically performing security actions to prevent a potential threat according to one or more embodiments. The vehicle includes 200 includes a computer system 202 configured to communicate over a network 250 with many different sensors, such as sensors 240A, sensors 240B through sensors 240N for capturing and recognizing a surrounding environment of the vehicle. The sensors 240A, 240B through 240N can generally be referred to as sensors 240 and are utilized to access the external environment of the vehicle 200.

For explanation purposes and not limitation, some example scenarios of the vehicle 200 are discussed. It should be appreciated that one or more embodiments are not limited to the example scenarios. For example, some example scenarios may identify the sensors 240A as light detection and ranging (LiDAR) sensors or laser imaging, detection, and ranging sensors. LiDAR sensors utilize a method for determining ranges by targeting an object or a surface with a laser and measuring the time for the reflected light to return to the receiver. LiDAR can operate in a fixed direction (e.g., horizontal) and/or it may scan multiple directions, in which case it is sometimes referred to as LiDAR scanning or three-dimensional (3D) laser scanning, which is a special combination of 3D scanning and laser scanning.

In many cases, the LiDAR is the main navigation mechanism on autonomous vehicles for Levels 3-5, and therefore by spoofing the LiDAR system an attacker can disrupt the autonomous navigation of the vehicle. A group of researchers were able to spoof the LiDAR of an autonomous vehicle to create artificial, non-existing objects in front of the vehicle such as, for example, a wall, another car, or even a pedestrian. This is a dangerous attack because that artificial obstacle keeps the vehicle stopped, which can be leveraged by an attacker to execute a variety of crimes including taking/removing the passenger(s) against his/her will, physically harming/attacking the passenger, robbing the passenger, etc. Additionally, spoofing the LiDAR of vehicles can be used to create disruption in many ways such as, for example, creating artificial traffic jams/congestion, supporting an attack having an unlawful use of violence and intimidation against civilians in a city/town/district, preventing the movement of first responders (e.g., police, fire department, ambulance, search and rescue, etc.), and blocking the movement of vehicles in a city/town/district to show support for a manifestation (such as a cybersecurity breach movement).

In one or more embodiments, the sensors 240 can be representative of any type of sensor equipment including, for example, radar sensors, video cameras, LiDAR sensors, ultrasonic sensors, thermal imaging sensors, etc., which capture information of the surrounding environment of the vehicle 200 for processing by vehicle control system 212.

The vehicle control system 212 includes various components, modules, engines, etc., and can be implemented as instructions stored on a computer-readable storage medium, as hardware modules, as special-purpose hardware (e.g., application specific hardware, application specific integrated circuits (ASICs), as embedded controllers, hardwired circuitry, etc.), and/or as some combination or combinations of these. In examples, the engine(s) described herein can be a combination of hardware and programming. The programming can be processor executable instructions stored on a tangible memory, and the hardware can include processing circuitry for executing those instructions. Thus, a system memory can store program instructions that when executed by processing circuitry implement the engines described herein. Other engines can also be utilized to include other features and functionality described in other examples herein. Alternatively or additionally, the vehicle control system 212 can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

The computer system 202 includes the vehicle control system 212, software applications 204, rules-based algorithm 224, NLP models 228, machine learning models 242, etc., and can include functionality and features of the computer system 100 in FIG. 1 including various hardware components and various software applications such as software 111 which can be executed as instructions on one or more processors 101 in order to perform actions according to one or more embodiments of the invention. The software application 204 can include, be integrated with, and/or call various other pieces of software, algorithms, application programming interfaces (APIs), speech-to-text software, text-to-speech software, etc., to operate as discussed herein. The software applications 204 may be representative of numerous software applications designed to work together. Each of the sensors 240A-240N are connected to the computer system 202 which can be wired and/or wiredly connected. Moreover, the network 250 can be a wired and/or wireless communication network.

The vehicle 200 can include a communications module 210 having a transmitter and receiver (e.g., a transceiver) for transmitting and receiving signals. The vehicle control system 212 provides control signals to various actuators 260 for steering, braking, acceleration, and other known functions of the vehicle 200, as understood by one of ordinary skill in the art.

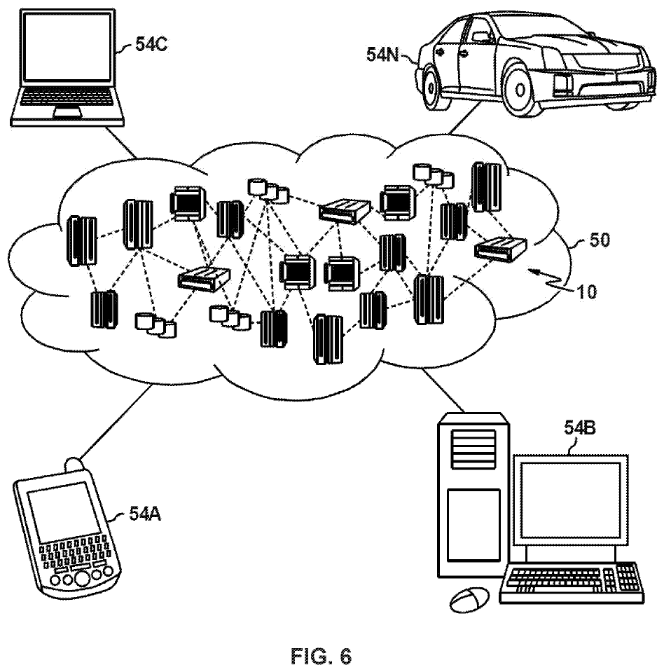

The computer system 202 may be representative of numerous computer systems and/or distributed computer systems configured to provide services to the vehicle 200. The computer system 202 can connect to a cloud computing environment such as a cloud computing environment 50 depicted in FIG. 6, as discussed further herein.

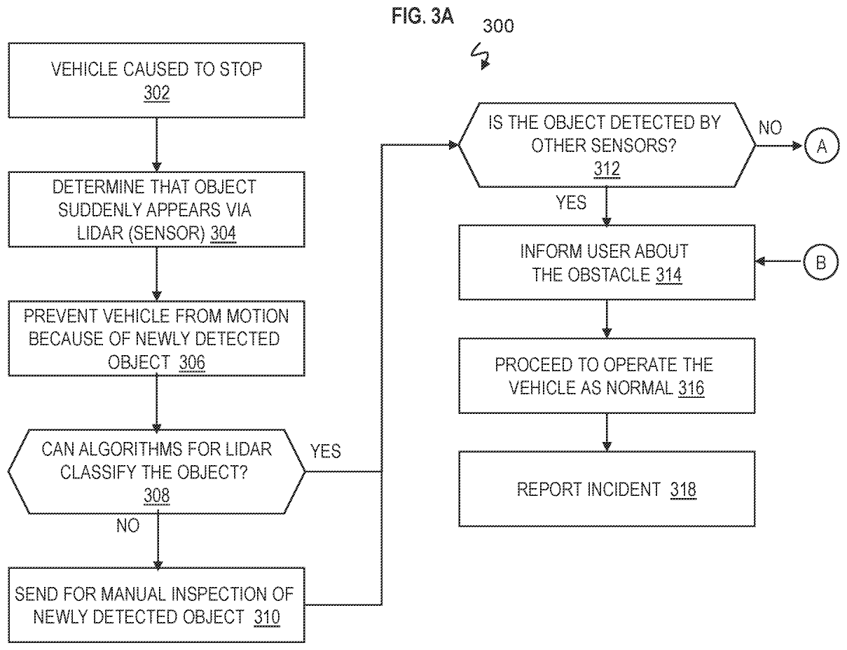

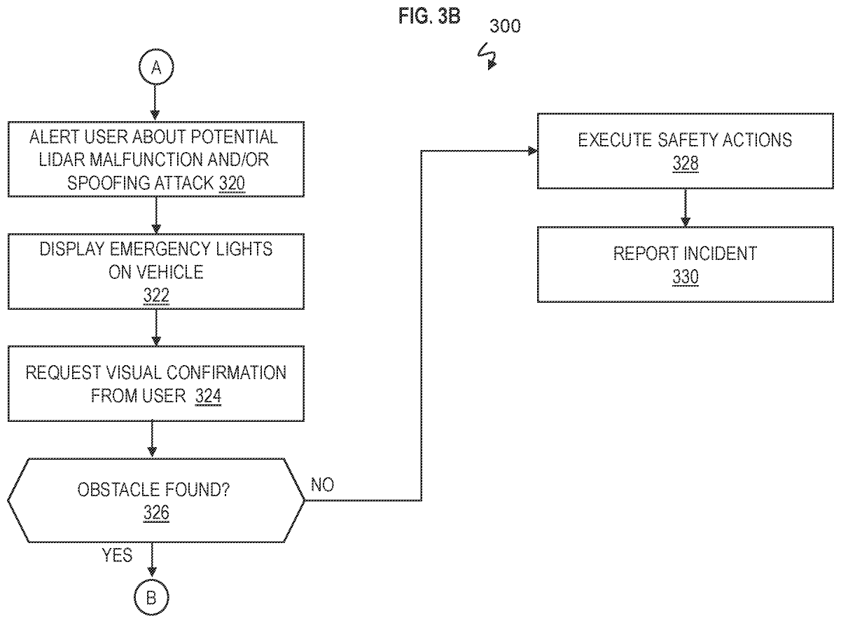

FIGS. 3A and 3B depict a flowchart of a computer-implemented method 300 for automatically identifying and mitigating spoofing attacks on autonomous vehicles and for automatically performing security actions to prevent a potential threat according to one or more embodiments. The computer-implemented method 300 is executed by the computer system 202. Reference can be made to any figures discussed herein.

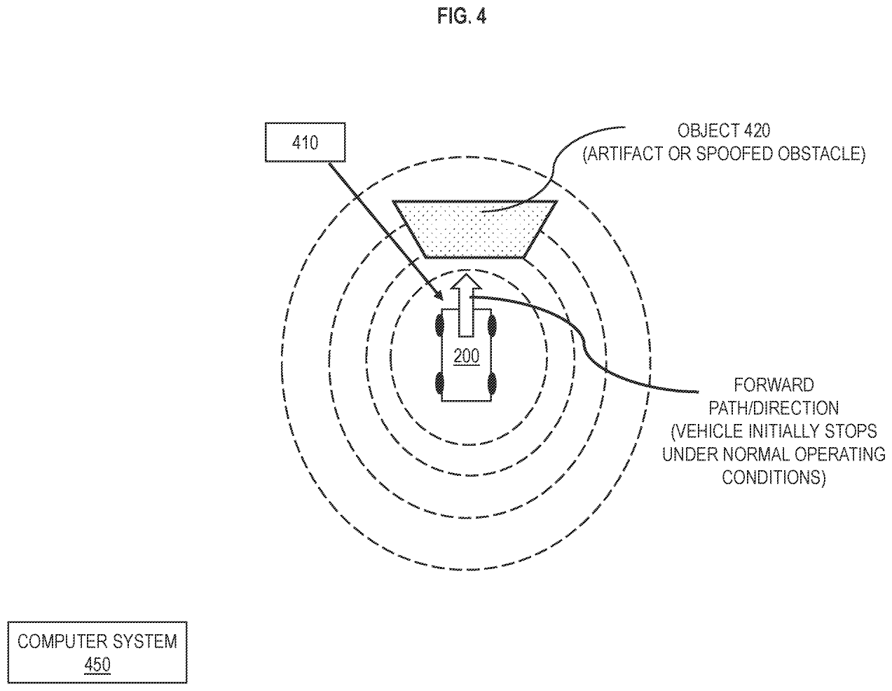

At block 302 of the computer-implemented method 300, the vehicle control system 212 is configured to cause the vehicle 200 to stop. The vehicle 200 can stop under normal conditions or operations associated with an event such as a red light detected, stop sign detected, crosswalk detected, intersection detected, railroad crossing detected, etc., as depicted in FIG. 4. Stopping under normal conditions or operations does not include stopping the vehicle or preventing the vehicle from moving during spoofing attacks through the LiDAR sensors 240A, where the spoofing attacks are intended to deceive some aspect of the vehicle control system 212 such as the rules-based algorithms, machine learning models 242, and/or any other software that processes the signals received from the LiDAR sensors 240A. In FIG. 4, an electronic radio frequency device 410 is transmitting laser pulses and/or radio waves in the wavelength of lasers to be captured by the LiDAR sensors 240A in order to spoof or deceive the vehicle control system 210. The terms spoofing attacks and deception attacks can be utilized interchangeably.

The spoofing attack is not as simple as just spoofing the LiDAR. In fact, researchers found that the success rate of only spoofing the LiDAR was below 8%. Instead, the attackers use a smart spoofing system via the electronic radio frequency device 410 or some other radio frequency transmitter to trick, not the LiDAR sensor (alone), but the machine learning algorithm or software that is in charge of analyzing the LiDAR inputs, thereby allowing the attacker to create fake obstacles.

The provided example scenario is keeping a stopped vehicle stopped for a longer period of time than under normal conditions or operation, such as a freezing attack on the vehicle 200. FIG. 4 depicts an example of the vehicle 200 initially stopped under any of the normal circumstances as controlled by the vehicle control system 212.

At block 304, the vehicle control system 212 is configured to determine that a new object 420 is suddenly in the path/direction of the vehicle 200, after the vehicle 200 has already been stopped under normal conditions or operations as depicted in FIG. 4.

At block 306, the vehicle control system 212 is configured to prevent the vehicle 200 from moving forward because the newly detected object 420 still appears to be present in the path of the vehicle 200, even though the vehicle control system 212 has confirmed that the event detected under the normal conditions or operations permits the vehicle 200 to start moving again. As such, the vehicle 200 is ready to be controlled to move forward again after stopping, but the sudden appearance of the newly detected object 420 prevents the vehicle 200 from moving forward. In this example, the newly detected object 420 is artificial, non-existing object generated by an attacker using the electronic radio frequency device 410.

At block 308, the vehicle control system 212 is configured to check whether algorithms for the LiDAR sensors can classify the newly detected object 420. In one or more embodiments, one or more rules-based algorithms 224 and/or machine learning models 242 may be utilized to classify objects detected by the sensors 240. Any suitable algorithms can be utilized to classify objects detected by the sensors 240, as understood by one of ordinary skill in the art.

At block 310, when (“NO”) the vehicle control system 212 cannot classify the newly detected object 420, the vehicle control system 212 is configured to send the captured information of the newly detected object 420 for manual inspection. In one or more embodiments, the vehicle control system 212 causes the communications module 210 to send the newly detected object 420 to a computer system 450 of an administrator for manual inspection of the captured information of the newly detected object 420. The computer system 450 may be part of the cloud computing environment 50 depicted in FIG. 6.

At block 312, when (“YES”) the vehicle control system 212 can classify the newly detected object 420, the vehicle control system 212 is configured to check if the object is detected by other sensors 240. In the example scenario, the LiDAR sensors 240A have been utilized to detect the object 420. In one or more embodiments, the vehicle control system 212 is configured to check whether sensors 240B-240N have detected the newly detected object 420, such as any one of the radar sensors, video cameras, ultrasonic sensors, thermal imaging sensors, etc. In the surrounding environment of the vehicle, the captured data of the sensors 240B-240N is processed by one or more rules-based algorithms 224 and/or machine learning models 242 for identification of any objects, or any suitable algorithms as understood by one of ordinary skill in the art.

At block 314, when (“YES”) the new object 420 is detected by at least one or more of the other sensors 240B-240N, the vehicle control system 212 is configured to inform the user (e.g., the passenger(s)) in the vehicle 200 about the detected object 420 (e.g., obstacle). For example, the vehicle control system 212 is configured to inform the user about the detected object 420 in front the path/direction of the vehicle 200 by any combination of an audible message through speakers 123 in the vehicle, a displayed message on a display 119 in the vehicle, a text message to a phone number of the passenger in the vehicle 200, a phone call to the passenger in the vehicle 200, etc.

At blocks 316 and 318, the vehicle control system 212 is configured to continue to operate the vehicle 200 as normal for the trip and report the incident.

At block 320, when (“NO”) the new object 420 is not detected by any one of the other sensors 240B-240N, the vehicle control system 212 is configured to alert the user (e.g., passenger(s)) about a potential spoofing attack and/or LiDAR malfunction. The alert (e.g., audio, video, text, and/or haptic) can be a combination of warning messages of the potential spoofing attack and/or LiDAR malfunction by an audible message through the speakers 123 in the vehicle 200, a displayed message on a display 119 in the vehicle, a text message to a phone number of the passenger in the vehicle 200, a phone call to the passenger in the vehicle 200, etc. The software applications 204 may employ, call, and/or instruct a speech-to-text engine (not shown) to covert the audio to text and a text-to-speech engine (not shown) to convert text-to-speech as understood by one of ordinary skill in the art. In one or more embodiments, the software applications 204 are configured employ, call, and/or include one or more cognitive engines, such as one or more natural language processing (NLP) models 228, to determine the intent of the user (e.g., passenger(s)).

At blocks 322 and 324, the vehicle control system 212 is configured to display emergency lights on the vehicle 200 and request visual recognition of the user to confirmation the newly detected object 420 in front of the vehicle 200.

At block 326, when (“YES”) the user visually confirms that the new object 420 is present in the path/direction of the vehicle control system 212, flow proceeds to block 314 and the vehicle control system 212 will report the situation to support engineers about the potential malfunction and continue with the trip. Any type of user interface can be utilized by the user to communicate with vehicle control system 212. The user interface can include a microphone 122 for voice commands that can be interpreted using one or more NLP models 228, a touch screen (e.g., display 119) on which the user can select “Yes” to confirm I see the object or “No” I do not see the object, video cameras that captures gestures, expressions, sign language, etc., of the user to determine “Yes” or “No”, and so forth.

At block 328, when (“NO”) the user indicates that he/she does not see/view the new object 420 presently in the path/direction of the vehicle control system 212, the vehicle control system 212 is configured to execute safety actions. One or more safety actions/procedures can be stored in a safety actions database 230. Example safety actions executed by the vehicle control system 212 include locking the doors, raising/closing the windows, contacting security services (such as the police, fire department, a local security agency, etc.), turning on or flashing lights (including hazard lights, headlamps, etc.), performing a livestream of the cameras to a secure contact (e.g., a predesignated friend, police, administrator, etc.), playing an audible warning through one or more designated external speakers to “move away from the vehicle security is on the way”, honking the horn, moving the vehicle in an evasive manner (e.g., repeatedly moving (slightly) forward and (slightly) backward, etc.

At block 330, the vehicle control system 212 is configured to report the incident and continue the trip.

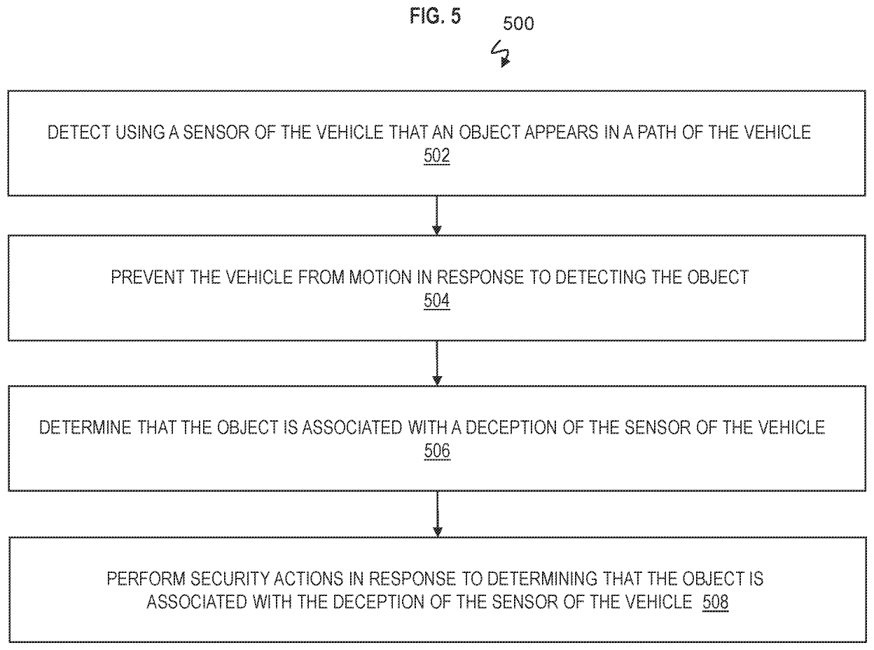

FIG. 5 is a flowchart of a computer-implemented method 500 for automatically identifying and mitigating spoofing attacks on autonomous vehicles by performing security actions according to one or more embodiments. Reference can be made to any figures discussed herein.

At block 502, the vehicle control system 212 is configured to detect using a sensor (e.g., sensors 240A) of the vehicle 200 that an object 420 appears in a path of the vehicle 200. At block 504, the vehicle control system 212 is configured to prevent the vehicle 200 from motion in response to detecting the object 420. At block 506, the vehicle control system 212 is configured to determine that the object 420 is associated with a deception (e.g., spoofing) of the sensor of the vehicle 200. At block 508, the vehicle control system 212 is configured to perform security actions (e.g., stored in the security actions database 230) in response to determining that the object 420 is associated with the deception of the sensor (e.g., sensors 240A) of the vehicle 200.

Detecting using the sensor of the vehicle 200 that the object appears in the path of the vehicle is in response to an event causing the vehicle 200 to stop or nearly stop, for example, as depicted in FIG. 4. Preventing the vehicle from motion in response to detecting the object includes causing the vehicle to stop or nearly stop for an event, where the vehicle normally moves (e.g., forward down the path/direction) in response to completion of the event; preventing the vehicle from normally moving in response to completion of the event because the object 420 is detected.

Determining that the object 420 is associated with the deception of the sensor of the vehicle comprises confirming that the object is not detected by one or more other sensors (e.g., sensors 240B-240N) of the vehicle 200. Determining that the object 420 is associated with the deception of the sensor (e.g., the LiDAR sensors 240A) of the vehicle 200 includes confirming that a user response (e.g., from the passenger(s) of the vehicle 200) indicates that the object 420 is not present. The security actions include one or more of alerting a user of a potential attack, locking doors of the vehicle, displaying emergency lights of the vehicle, contacting security services, performing a livestream from a camera of the vehicle to a designated contact, causing emergency sounds from the vehicle, and/or causing a predesignated type of movement (e.g., evasive moment) of the vehicle to avoid theft.

The deception of the sensor (e.g., the LiDAR sensors 240A) of the vehicle 200 includes receiving laser pulses (e.g., from electronic radio frequency device 410) by the sensor such that the laser pulses cause algorithms to detect an appearance of the object when the object is not physically present in a proximity of the vehicle.

In one or more embodiments, the machine learning models 242 and/or NLP models 228 can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets can be utilized to train the machine learning algorithms. The training datasets can include historical data of past tickets and the corresponding options/suggestions/resolutions provided for the respective tickets. Labels of options/suggestions can be applied to respective tickets to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

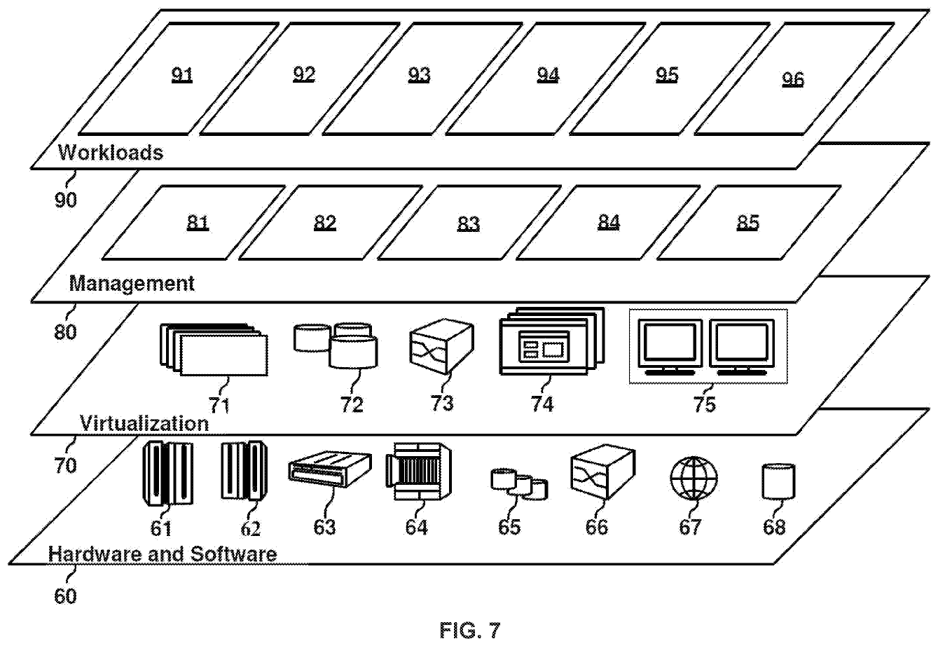

Referring now to FIG. 7, a set of functional abstraction layers provided by cloud computing environment 50 (depicted in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
detecting using a sensor of a vehicle that an object appears in a path of the vehicle;
preventing the vehicle from motion in response to detecting the object;
determining that the object is associated with a deception of the sensor of the vehicle; and
performing security actions in response to determining that the object is associated with the deception of the sensor of the vehicle.

2. The computer-implemented method of claim 1, wherein detecting using the sensor of the vehicle that the object appears in the path of the vehicle is in response to an event causing the vehicle to stop or nearly stop.

3. The computer-implemented method of claim 1, wherein preventing the vehicle from motion in response to detecting the object comprises:
causing the vehicle to stop or nearly stop for an event, where the vehicle normally moves in response to completion of the event; and
preventing the vehicle from normally moving in response to completion of the event because the object is detected.

4. The computer-implemented method of claim 1, wherein determining that the object is associated with the deception of the sensor of the vehicle comprises confirming that the object is not detected by one or more other sensors of the vehicle.

5. The computer-implemented method of claim 1, wherein determining that the object is associated with the deception of the sensor of the vehicle comprises confirming that a user response indicates that the object is not present.

6. The computer-implemented method of claim 1, wherein the security actions comprise at least one of alerting a user of a potential attack, locking doors of the vehicle, displaying emergency lights of the vehicle, contacting security services, performing a livestream from a camera of the vehicle to a designated contact, causing emergency sounds from the vehicle, or causing a predesignated type of movement of the vehicle to avoid theft.

7. The computer-implemented method of claim 1, wherein the deception of the sensor of the vehicle comprises receiving laser pulses by the sensor such that the laser pulses cause algorithms to detect an appearance of the object when the object is not physically present in a proximity of the vehicle.

8. A system comprising:
a memory having computer readable instructions; and
one or more processors for executing the computer readable instructions, the computer readable instructions controlling the one or more processors to perform operations comprising:
detecting using a sensor of a vehicle that an object appears in a path of the vehicle;
preventing the vehicle from motion in response to detecting the object;
determining that the object is associated with a deception of the sensor of the vehicle; and
performing security actions in response to determining that the object is associated with the deception of the sensor of the vehicle.

9. The system of claim 8, wherein detecting using the sensor of the vehicle that the object appears in the path of the vehicle is in response to an event causing the vehicle to stop or nearly stop.

10. The system of claim 8, wherein preventing the vehicle from motion in response to detecting the object comprises:
causing the vehicle to stop or nearly stop for an event, where the vehicle normally moves in response to completion of the event; and
preventing the vehicle from normally moving in response to completion of the event because the object is detected.

11. The system of claim 8, wherein determining that the object is associated with the deception of the sensor of the vehicle comprises confirming that the object is not detected by one or more other sensors of the vehicle.

12. The system of claim 8, wherein determining that the object is associated with the deception of the sensor of the vehicle comprises confirming that a user response indicates that the object is not present.

13. The system of claim 8, wherein the security actions comprise at least one of alerting a user of a potential attack, locking doors of the vehicle, displaying emergency lights of the vehicle, contacting security services, performing a livestream from a camera of the vehicle to a designated contact, causing emergency sounds from the vehicle, or causing a predesignated type of movement of the vehicle to avoid theft.

14. The system of claim 8, wherein the deception of the sensor of the vehicle comprises receiving laser pulses by the sensor such that the laser pulses cause algorithms to detect an appearance of the object when the object is not physically present in a proximity of the vehicle.

15. A computer program product comprising a computer readable storage medium having program instructions embodied therewith, the program instructions executable by one or more processors to cause the one or more processors to perform operations comprising:
detecting using a sensor of a vehicle that an object appears in a path of the vehicle;
preventing the vehicle from motion in response to detecting the object;
determining that the object is associated with a deception of the sensor of the vehicle; and
performing security actions in response to determining that the object is associated with the deception of the sensor of the vehicle.

16. The computer program product of claim 15, wherein detecting using the sensor of the vehicle that the object appears in the path of the vehicle is in response to an event causing the vehicle to stop or nearly stop.

17. The computer program product of claim 15, wherein preventing the vehicle from motion in response to detecting the object comprises:
causing the vehicle to stop or nearly stop for an event, where the vehicle normally moves in response to completion of the event; and
preventing the vehicle from normally moving in response to completion of the event because the object is detected.

18. The computer program product of claim 15, wherein determining that the object is associated with the deception of the sensor of the vehicle comprises confirming that the object is not detected by one or more other sensors of the vehicle.

19. The computer program product of claim 15, wherein determining that the object is associated with the deception of the sensor of the vehicle comprises confirming that a user response indicates that the object is not present.

20. The computer program product of claim 15, wherein the security actions comprise at least one of alerting a user of a potential attack, locking doors of the vehicle, displaying emergency lights of the vehicle, contacting security services, performing a livestream from a camera of the vehicle to a designated contact, causing emergency sounds from the vehicle, or causing a predesignated type of movement of the vehicle to avoid theft.
